(19) United States
(12) Patent Application Publication
(10) Pub. No.: US 2011/0248474 A1
(43) Pub. Date: Oct. 13, 2011

(54) TOW BAR SUSPENSION SYSTEM

(75) Inventors: Chris D. Williams, Plankinton, SD (US); Robert C. Tilton, Mitchell, SD (US)

(73) Assignee: TRAIL KING INDUSTRIES, INC., Mitchell, SD (US)

(21) Appl. No.: 12/885,633

(22) Filed: Sep. 20, 2010

Related U.S. Application Data
(60) Provisional application No. 61/322,173, filed on Apr. 8, 2010.

(51) Int. Cl. B60D 1/46; B23P 17/04; B60D 1/02

(52) U.S. Cl. 280/482; 280/504; 280/515; 29/428

(57) ABSTRACT

A tow bar suspension system includes a tow bar pivotally connected to a trailer frame, first and second mounts coupling the suspension bar to the tow bar, an elongate connector, and a coupling link. The connector couples the coupling link and the suspension bar, while the coupling link couples the connection bracket and the trailer frame. The suspension bar is angled with respect to a longitudinal axis of the tow bar such that the weight of the tow bar is applied as a torsion force on the suspension bar, which resists this force to suspend the tow bar off a ground surface. The coupling link is adjustable in length to modify the pitch of the tow bar with respect to the ground surface.

### TECHNICAL FIELD

This invention relates to tow bars for connecting a trailer to a towing vehicle, and more specifically to suspension systems for keeping the tow bar from pivoting into contact with the ground.

### BACKGROUND

Tow bars are conventionally used to couple a towing vehicle with a trailer. Typically, the tow bar is mounted pivotally on the trailer frame such that the tow bar can rotate to engage a hitch mount of varying heights on a towing vehicle or withstand hills and bumps in a road during operation. As a result of this pivotal mounting, the weight of the tow bar tends to rotate the tow bar towards the ground when disconnected from a towing vehicle. If the tow bar is not firmly held by a user when connecting or disconnecting the tow bar from the towing vehicle, the tow bar may fall to the ground and be damaged by the resultant impact. To prevent this impact damage, conventional suspension systems have been installed on tow bars.

Conventional suspension systems include coil springs and swivel jacks. However, these conventional suspension systems have significant drawbacks. Swivel jacks contact the ground to support the tow bar, and thus do not permit the trailer and the tow bar to be moved easily when the trailer is disconnected from a towing vehicle. Coil springs add significant weight to the tow bar and do not permit adjustment of the pitch of the tow bar for different towing vehicle heights.

Consequently, it would be desirable to provide a tow bar suspension system that addresses these and other problems of conventional suspension systems.

### SUMMARY

A tow bar suspension system according to one embodiment of the present invention suspends a tow bar pivotally connected to a trailer frame. The tow bar suspension system includes an elongate suspension bar having first and second ends. The tow bar suspension system also includes first and second mounts, an elongate connector, and a coupling link. The first mount couples the first end of the suspension bar to the tow bar, and the second mount couples the second end of the suspension bar to the tow bar. The connector includes a first end coupled to the second end of the suspension bar and a second end coupled to the coupling link. The coupling link is also coupled to the trailer frame. The suspension bar defines a suspension bar axis which is angled with respect to a longitudinal axis of the tow bar such that the weight of the tow bar is applied to the suspension bar as a torsion force. The suspension bar resists this torsion force to suspend the tow bar from a ground surface.

In another embodiment of the tow bar suspension system, the system again includes a suspension bar, first and second mounts, an elongate connector, and a coupling link. The coupling link has an adjustable length so that the pitch of the tow bar may be modified by changing the length of the coupling link. The coupling link may further include a threaded bolt and a threaded receptacle. The threaded bolt is configured to be rotated by a hand tool to adjust the length of the coupling link. The coupling link is connected to the trailer frame with an individual pivot pin such that the coupling link and the tow bar suspension system are easily removed from the trailer frame when the tow bar is disconnected from the trailer frame.

The present invention also includes a method of suspending a tow bar pivotally connected to a trailer frame with a tow bar suspension system. The method includes coupling first and second ends of a suspension bar to the tow bar such that the suspension bar is angled with respect to the tow bar. The method further includes coupling the connector to the second end of the suspension bar and coupling the connector and the trailer frame with a coupling link. The suspension bar is configured to resist torsion applied by the weight of the tow bar, to thereby suspend the tow bar from a ground surface.

### BRIEF DESCRIPTION OF THE DRAWINGS

The accompanying drawings, which are incorporated in and constitute a part of this specification, illustrate an embodiment of the invention and, together with a general description of the invention given below, serve to explain the principles of the embodiment of the invention.

FIG. 1 is a perspective view of one embodiment of a tow bar suspension system according to the invention installed on a tow bar and trailer frame (partially shown in phantom).

FIG. 2 is an elevation view of the tow bar suspension system and tow bar of FIG. 1.

FIG. 3 is a detailed elevation view of the tow bar suspension system and tow bar of FIG. 1.

FIG. 4 is a perspective view of the tow bar suspension system of FIG. 1, with the tow bar and the trailer frame shown in phantom.

FIG. 5 is a perspective view of the connection bracket and coupling link of the tow bar suspension system of FIG. 1, illustrating the adjustment of the coupling link.

FIG. 6 is a partially exploded view of the connection bracket and coupling link of the tow bar suspension system of FIG. 5, illustrating the disconnection of the tow bar suspension system from the trailer frame.

### DETAILED DESCRIPTION

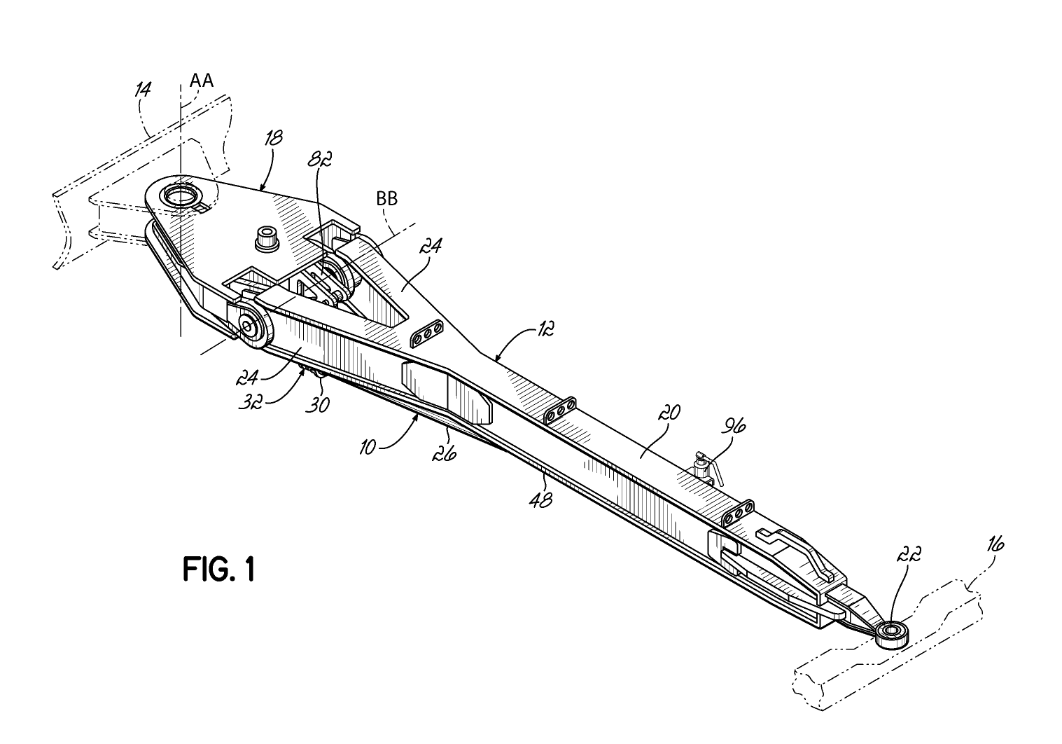

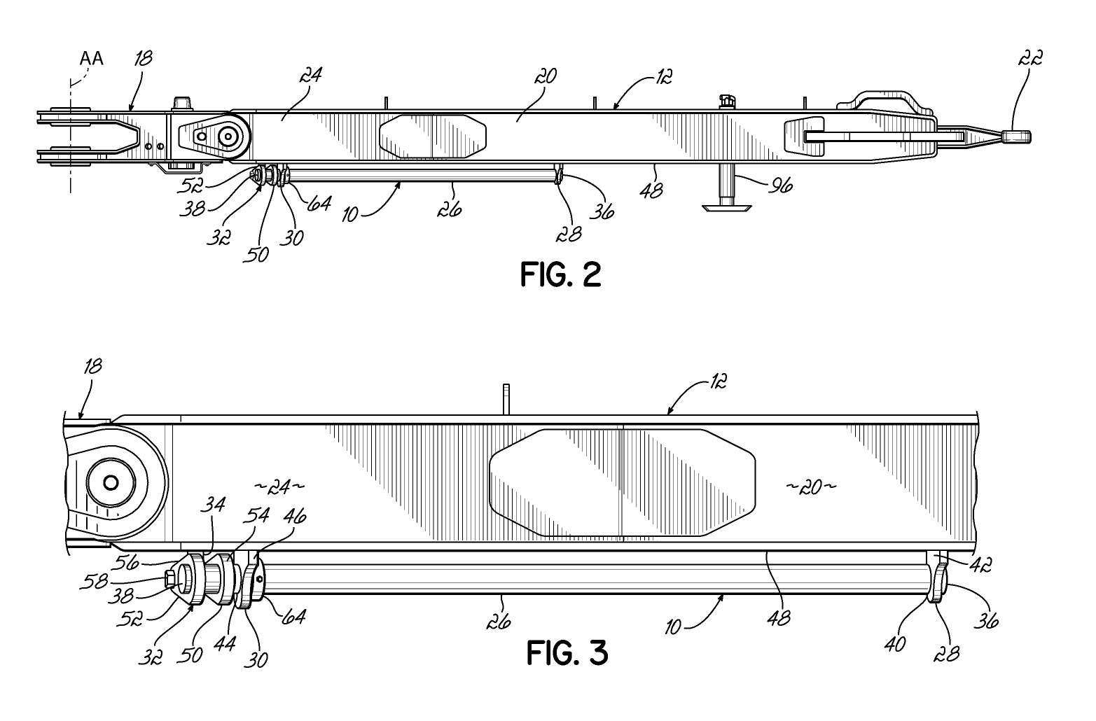

FIGS. 1-6 illustrate an exemplary embodiment of a tow bar suspension system 10 for suspending a tow bar 12 pivotally connected to a trailer frame 14. The tow bar 12 is configured to be coupled to a towing vehicle 16 partially shown in phantom in FIG. 1. The tow bar suspension system 10 includes a trailer pivot assembly 18 that pivotally couples to the trailer frame 14 about a generally vertical axis AA and pivotally couples to the tow bar 12 about a generally horizontal axis BB. It will be appreciated that the trailer pivot assembly 18 may be considered an element of the tow bar 12 without departing from the general scope of the invention. The tow bar 12 is a generally Y-shaped member having a front bar portion 20 with a hitch connection ring 22 and a pair of rear bar portions 24 coupled to the trailer pivot assembly 18. The tow bar suspension system 10 couples to the tow bar 12 and the trailer frame 14 at the trailer pivot assembly 18, and is operable to suspend the tow bar 12 from a ground surface, as described in further detail below.

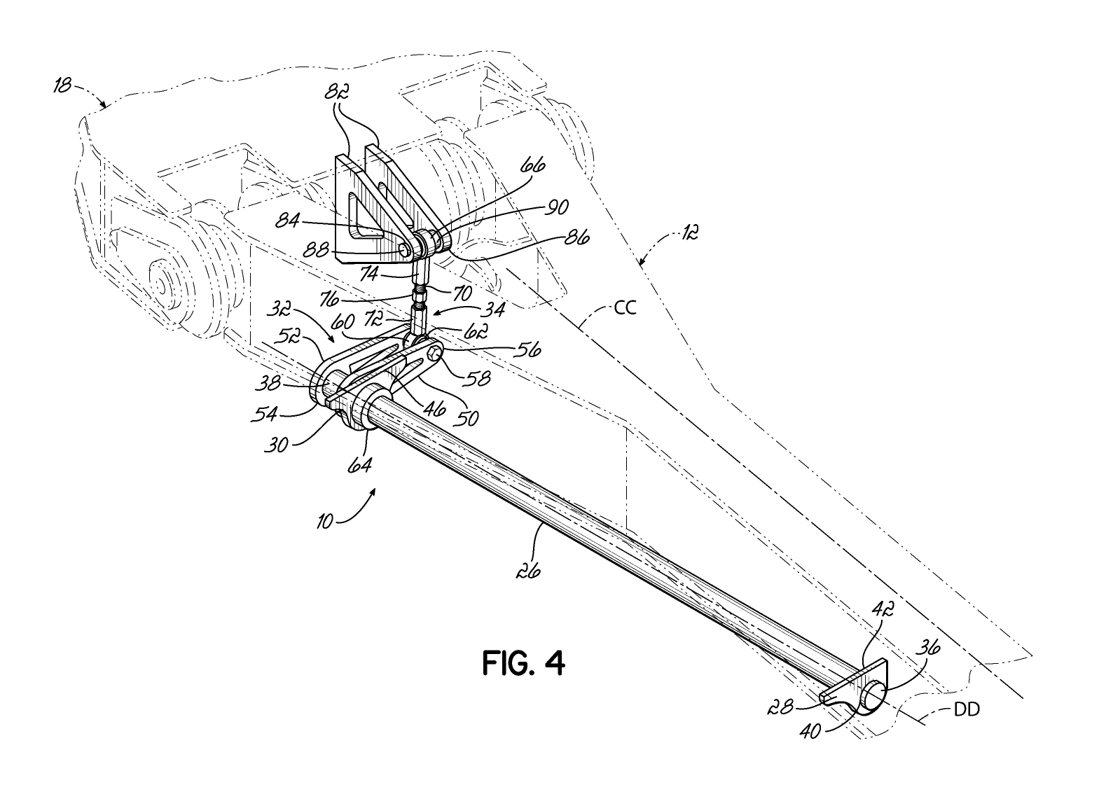

As shown in FIGS. 1-3 and most clearly in FIG. 4, the tow bar suspension system 10 includes a suspension bar 26, a first mounting bracket 28, a second mounting bracket 30, an elongate connection bracket 32, and a coupling link 34. The suspension bar 26 is an elongated member having a first end 36 and a second end 38. Although the suspension bar 26 preferably has a generally circular cross-section, bars having other cross-sections may be used. The first mounting bracket 28 is a plate member including an aperture 40 for receiving the first end 36 of the suspension bar 26. The first end 36 of the suspension bar 26 is coupled to the first mounting bracket 28 at the aperture 40. The first mounting bracket 28 also includes an elongate upper edge 42 configured to be coupled to the front bar portion 20 of the tow bar 12. In a similar manner, the second mounting bracket 30 includes an aperture 44 for receiving and being coupled to the second end 38 of the suspension bar 26. The second mounting bracket 30 also includes an elongate upper edge 46 configured to be coupled to one of the rear bar portions 26 of the tow bar 12. Preferably the mounting brackets 28, 30 are permanently coupled to the suspension bar 26 and tow bar 12, such as by welding, but any known technique for securely coupling the components may be used. In the illustrated embodiment, the first mounting bracket 28 and the second mounting bracket 30 are coupled to a lower side 48 of the tow bar 12 such that the suspension bar 26 is located directly underneath the tow bar 12 when installed.

The connection bracket 32 includes a first bracket plate 50 and a second bracket plate 52 generally parallel to the first bracket plate 50. The first and second bracket plates 50, 52 collectively define a first bracket end 54 coupled to the second end 38 of the suspension bar 26. The first and second bracket plates 50, 52 also collectively define a second bracket end 56 having a first pivot pin 58 extending between the first and second bracket plates 50, 52. The first pivot pin 58 is configured to receive a first link end 60 of the coupling link 34 and a pair of spacer bushings 62 disposed between the first link end 60 and the respective first and second bracket plates 50, 52. Thus, the connection bracket 32 is rigidly coupled to the suspension bar 26 and pivotally coupled to the coupling link 34. It will be appreciated that a support bushing 64 may also be provided on the suspension bar 26 adjacent to the second mounting bracket 30 (as shown in the figures) or adjacent the first mounting bracket 28 and the connection bracket 32 in some embodiments of the tow bar suspension system 10.

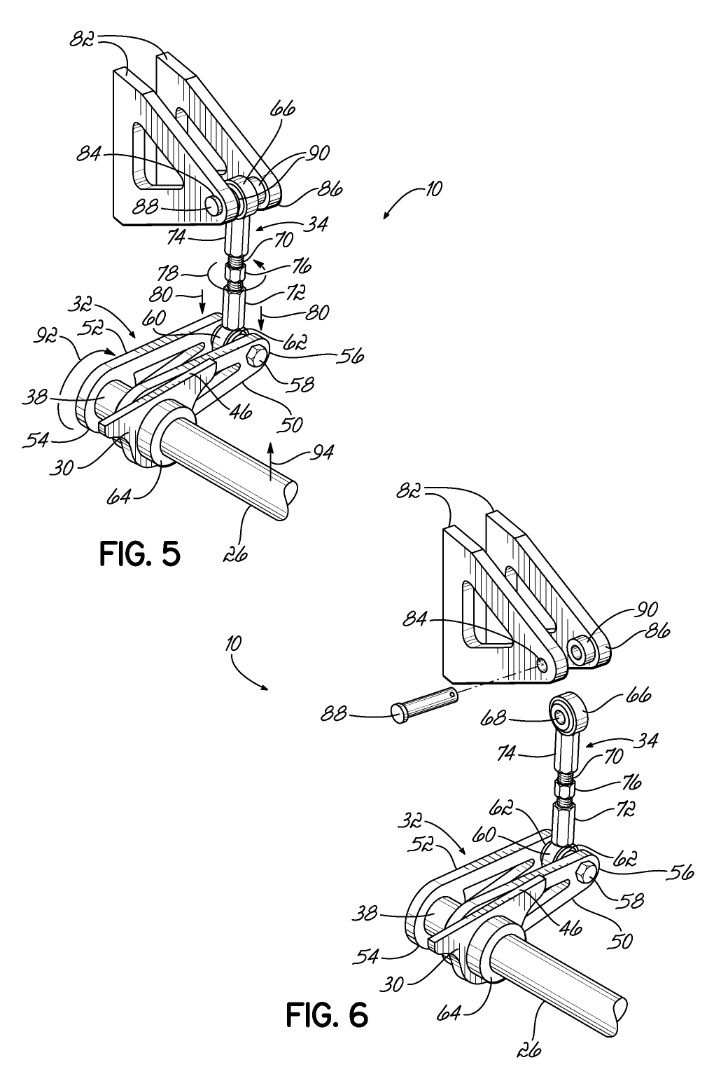

The coupling link 34 is illustrated in detail in FIGS. 5 and 6. The coupling link 34 includes the first link end 60 and a second link end 66 having an aperture 68 for receiving the pivot pin 58. The coupling link 34 also includes a threaded bolt 70 and a first threaded receptacle 72 extending from the first link end 60. The coupling link 34 may also include a second threaded receptacle 74 extending from the second link end 66 to engage the threaded bolt 70 as shown. The threaded bolt 70 includes a drive head 76 disposed between the first and second threaded receptacles 72, 74. The drive head 76 may be used to adjust the length of the coupling link 34. In particular, the threaded bolt 70 and first and second receptacles 72, 74 are threaded such that counterclockwise rotation of the drive head 76 with a hand tool (as shown by arrow 78 in FIG. 5) increases the distance between the first and second link ends 60, 66 (as schematically shown by arrows 80 in FIG. 5). It will be appreciated that only a single threaded receptacle may be provided in other embodiments of the tow bar suspension system 10 without departing from the scope of the invention. Likewise, other mechanisms known in the art that enable altering the distance between first and second link ends 60, 66 may also be used.

The tow bar suspension system 10 further includes trailer mounting brackets 82 coupled to the trailer pivot assembly 18. As shown in FIG. 6, each of the trailer mounting brackets 82 has a generally triangular shape with an aperture 84 at a front end 86 for receiving a second pivot pin 88. The second pivot pin 88 extends through each of the trailer mounting brackets 82 and the aperture 68 in the second link end 66 of the coupling link 34. A pair of spacer bushings 90 (only one visible in FIG. 6) is also provided between the second link end 66 and the respective trailer mounting brackets 82. Thus, the coupling link 34 is pivotally connected to the connection bracket 32 at the first link end 60 and pivotally connected to the trailer pivot assembly 18 at the second link end 66. The second pivot pin 88 is configured to be removable to release the coupling link 34 and the tow bar suspension system 10 from the trailer frame 14 when the tow bar 12 is disconnected from the trailer frame 14. In this regard, disconnection of the tow bar 12 from the trailer frame 14 is simplified from previously-described conventional suspension systems.

As most clearly shown in FIG. 4, the tow bar 12 extends along a longitudinal axis CC. The suspension bar 26 defines a suspension bar axis DD along its length, the suspension bar axis DD being angled with respect to the longitudinal axis CC of the tow bar 12. Consequently, the weight of the tow bar 12 is effectively applied as a torsion force on the suspension bar 26. The torsion force is schematically illustrated by arrow 92 in FIG. 5, and the torsion force is resisted by the suspension bar 26 because the suspension bar 26 is rigidly coupled in position by the connection bracket 32. The resistance to the torsion force acts to suspend the tow bar 12 above a ground surface as shown schematically by arrow 94 in FIG. 5. Consequently, the resistance of the suspension bar 26 to the torsion force maintains the pitch or angle of the tow bar 12 with respect to the trailer frame 14.

In operation, the tow bar 12 may be connected to towing vehicles 16 of various heights, thereby requiring a different pitch of the tow bar 12 with respect to the trailer frame 14. The tow bar suspension system 10 enables a user to set the pitch of the tow bar 12 by adjusting the length of the coupling link 34. As the threaded bolt 70 is rotated to lengthen the coupling link 34 as previously described, the second bracket end 56 of the connection bracket 32 moves downwardly. Because of the rigid connection of the connection bracket 32 to the second end 38 of the suspension bar 26, the downward movement of the second bracket end 56 causes a rotation of the suspension bar 26 at the second end 38. This leads to a corresponding rotation of the first end 36 of the suspension bar 26, which effectively rotates the tow bar 12 towards the ground (decreasing the pitch) as a result of the weight of the tow bar 12. It will be appreciated that the pitch of the tow bar 12 may be increased by adjusting the length of the coupling link 34 in an opposite manner. Thus, the pitch of the tow bar 12 may be easily adjusted with a hand tool.

The tow bar 12 may include an adjustable stand 96 to support the tow bar 12 when the trailer is not connected to the towing vehicle 16. The tow bar suspension system 10 prevents impact damage to this adjustable stand 96, the hitch connection ring 22, and the lower side 48 of the tow bar 12 by limiting the pivoting movement of the tow bar 12 with respect to the trailer frame 14. When the tow bar 12 and trailer are disconnected from the towing vehicle 16, the tow bar suspension system 10 allows a user to move the trailer and tow bar 12 without picking up and supporting the full weight of the tow bar 12 while moving the trailer. The tow bar suspension system 10 also permits easy one-step adjustment of the pitch of the tow bar 12, and one-step disconnection of the tow bar suspension system 10 from the trailer frame 14. Thus, the tow bar suspension assembly 10 improves human control and interaction with the tow bar 12 and the trailer. In this regard, the tow bar suspension system 10 addresses many of the drawbacks of conventional tow bar suspension devices and systems.

While the present invention has been illustrated by the description of the embodiment thereof, and while the embodiment has been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details representative apparatus and method, and illustrative examples shown and described. Accordingly, departures may be made from such details without departure from the spirit or scope of applicant's general inventive concept.

1. A tow bar suspension system, comprising:
a tow bar pivotally connected to a trailer frame and defining a longitudinal axis between the trailer frame and a towing vehicle;
an elongate suspension bar including a first end and a second end, the suspension bar defining a suspension bar axis from the first end to the second end;
a first mount coupling the first end of the suspension bar and the tow bar;
a second mount coupling the second end of the suspension bar and the tow bar;
an elongate connector including a first end coupled to the second end of the suspension bar, and a second end; and
a coupling link including a first link end coupled to the second end of the elongate connector, and a second link end coupled to the trailer frame,
wherein the suspension bar axis is angled from the longitudinal axis of the tow bar such that the weight of the tow bar is applied as torsion on the suspension bar, which is configured to resist torsion to suspend the tow bar from a ground surface.

2. The tow bar suspension system of claim 1, wherein the coupling link has an adjustable length between the first link end and the second link end, and adjusting the length of the coupling link modifies a pitch of the tow bar longitudinal axis with respect to the ground surface.

3. The tow bar suspension system of claim 2, wherein the coupling link includes a threaded bolt and a threaded receptacle, the threaded bolt configured to be rotated by a hand tool to adjust the length of the coupling link.

4. The tow bar suspension system of claim 1, wherein the coupling link is coupled to the trailer frame with a pivot pin.

5. The tow bar suspension system of claim 1, wherein the suspension bar is a generally cylindrical member.

6. The tow bar suspension system of claim 1, wherein the tow bar includes a lower side, and the suspension bar is coupled to the lower side of the tow bar by the first and second mounts.

7. A tow bar suspension system comprising:
a tow bar pivotally connected to a trailer frame;
an elongate suspension bar including a first end and a second end;
a first mount coupling the first end of the suspension bar and the tow bar;
a second mount coupling the second end of the suspension bar and the tow bar;
an elongate connector including a first end coupled to the second end of the suspension bar, and a second end; and
a coupling link including a first link end coupled to the second end of the elongate connector, and a second link end coupled to the trailer frame,
wherein the suspension bar is configured to support the weight of the tow bar, and the coupling link has an adjustable length between the first link end and the second link end such that a pitch of the tow bar with respect to a ground surface may be modified by adjusting the length of the coupling link.

8. The tow bar suspension system of claim 7, wherein the coupling link includes a threaded bolt and a threaded receptacle, the threaded bolt configured to be rotated by a hand tool to adjust the length of the coupling link.

9. The tow bar suspension system of claim 7, wherein the coupling link is coupled to the trailer frame with a pivot pin.

10. The tow bar suspension system of claim 7, wherein the suspension bar is a generally cylindrical member.

11. The tow bar suspension system of claim 10, wherein the tow bar defines a longitudinal axis from the trailer frame to a towing vehicle, the suspension bar defines a suspension bar axis from the first end to the second end, and the suspension bar axis is angled with respect to the longitudinal axis of the tow bar such that the weight of the tow bar is applied as torsion on the suspension bar.

12. The tow bar suspension system of claim 7, wherein the tow bar includes a lower side, and the suspension bar is coupled to the lower side of the tow bar by the first and second mounts.

13. A method of suspending a tow bar pivotally connected to a trailer frame with a tow bar suspension system including a suspension bar with a first end and a second end, a connector, and a coupling link, the method comprising:
coupling the first end and the second end of the suspension bar to the tow bar such that the suspension bar is angled with respect to a longitudinal axis of the tow bar;
coupling the connector to the second end of the suspension bar; and
coupling the coupling link to the trailer frame and the connector such that the weight of the tow bar is applied as a torsion force to the suspension bar,
wherein the suspension bar is configured to resist torsion to suspend the tow bar from a ground surface.

14. The method of claim 13, further comprising:
adjusting a length of the coupling link to modify a pitch of the tow bar with respect to the ground surface.

15. The method of claim 14, wherein the coupling link further includes a threaded bolt and a threaded receptacle, and adjusting a length of the coupling link comprises rotating the threaded bolt with respect to the threaded receptacle to adjust the length of the coupling link.
